(19) United States
(12) Patent Application Publication
(10) Pub. No.: US 2016/0337494 A1
(43) Pub. Date: Nov. 17, 2016

(54) PORTABLE ELECTRONIC DEVICE INTEGRATED WITH EXTENDABLE AND RETRACTABLE HEADSET ASSEMBLY

(71) Applicant: Chiun Mai Communication Systems, Inc., New Taipei (TW)

(72) Inventors: PEI-SHUANG HUANG, New Taipei (TW); KAI-LUN YU, New Taipei (TW)

(21) Appl. No.: 14/708,442

(22) Filed: May 11, 2015

(51) Int. Cl. H04M 1/60

(52) U.S. Cl. CPC H04M 1/6058

(57) ABSTRACT

A portable electronic device defines a substantially enclosed interior space and includes a detecting pin, a processor and a reeling mechanism. The reeling mechanism drives a headset assembly to be withdrawn from and retracted into the enclosed interior space. The reeling mechanism includes an urging member. When the headset assembly is withdrawn from the enclosed interior space, the urging member is in an elastically deformed state and the detecting pin is floating and triggers a first control signal to the processor. The processor activates the headset assembly in response to the first control signal. When the headset assembly is refracted into the enclosed interior space, the urging member returns to its original state and is electronically contacted with the detecting pin and the detecting pin triggers a second control signal to the processor. The processor inactivates the headset assembly in response to the second control signal.

### FIELD

The subject matter herein generally relates to portable electronic devices, and particularly to a portable electronic device integrated with a headset assembly which can be withdrawn from and retracted into the portable electronic device.

### BACKGROUND

The popularity of portable electronic devices, such as cellular telephones, personal data assistants (PDAs), etc., continues to increase each year. To maintain this trend, manufacturers continue to explore ways to make the portable electronic devices appeal to a larger percentage of the population. One area of focus involves headsets because the headsets free-up a user's hands while the user communicates with friends and colleagues using their portable electronic devices. However, since the headsets are separate from the portable electronic devices, the user has to separately carry the headsets.

### BRIEF DESCRIPTION OF THE DRAWINGS

Implementations of the present technology will now be described, by way of example only, with reference to the attached figures.

FIG. 1 is an exploded, isometric view of a portable electronic device integrated with a headset assembly, according to a first exemplary embodiment.

FIG. 2 is an enlarged view of a circled portion II of FIG. 1.

FIG. 3 is a partially assembled, isometric view of the portable electronic device of FIG. 1.

FIG. 4 is an assembled, isometric view of the portable electronic device of FIG. 1, while the headset assembly is withdrawn from the portable electronic device.

FIG. 5 is an assembled, isometric view of the portable electronic device of FIG. 1, while the headset assembly is retracted into the portable electronic device.

FIG. 6 is an exploded, isometric view of a portable electronic device integrated with a headset module, according to a second exemplary embodiment.

FIG. 7 is an assembled, isometric view of the headset module of FIG. 6, while a headset assembly of the headset module is retracted into the headset module.

FIG. 8 is an assembled, isometric view of the headset module of FIG. 6, while the headset assembly of the headset module is withdrawn from the headset module.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a portable electronic device integrated with an extendable and retractable headset assembly.

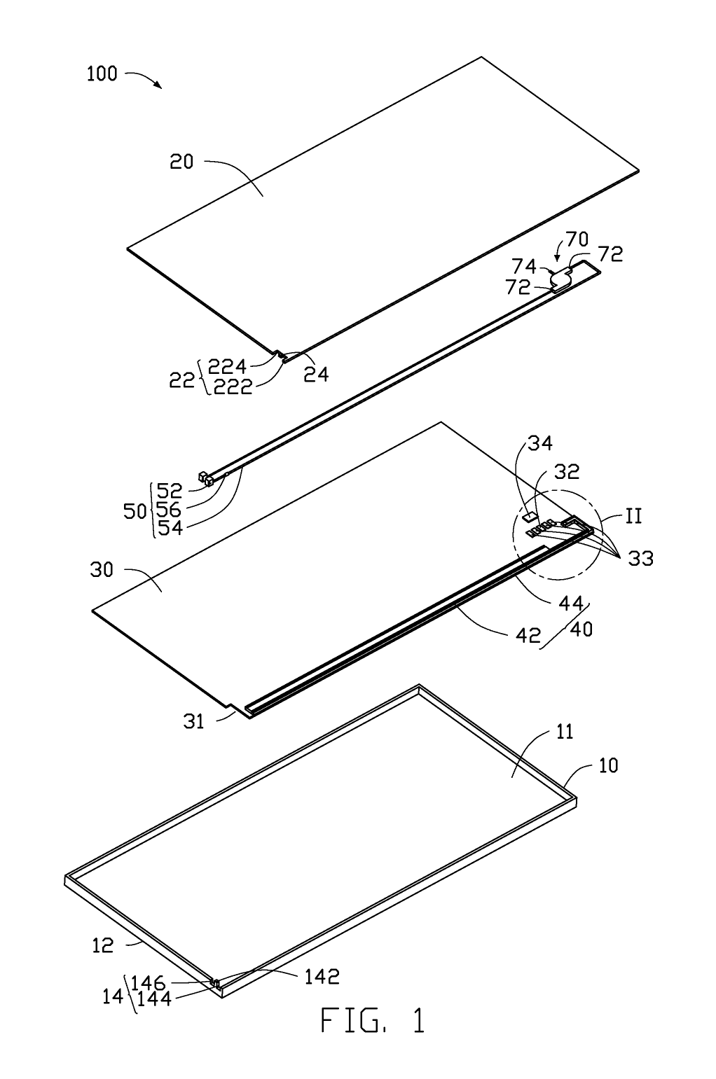

FIG. 1 illustrates an embodiment of a portable electronic device 100 employing a headset assembly 50, according to a first exemplary embodiment. The portable electronic device 100 can be a mobile phone, a personal data assistant (PDA), a tablet, or an intelligent watch, for example (details not shown).

The portable electronic device 100 further includes a housing 10, a battery cover 20 engaging with the housing 10, a printed circuit board (PCB) 30, a rail 40, and a reeling mechanism 70. The battery cover 20 engages with the housing 10 to form a substantially enclosed interior space to receive the reeling mechanism 70.

The housing 10 encases electric components of the portable electronic device 100 and the electric components typically include user interface components, such as a touch screen (not shown). The housing 10 includes a bottom plate 11 and at least one peripheral plate 12 surrounding the bottom plate 11. The at least one peripheral plate 12 defines an opening 14, and a protrusion 142 is protruded from the at least one peripheral plate 12 to divide the opening 14 into a first opening 144 and a second opening 146.

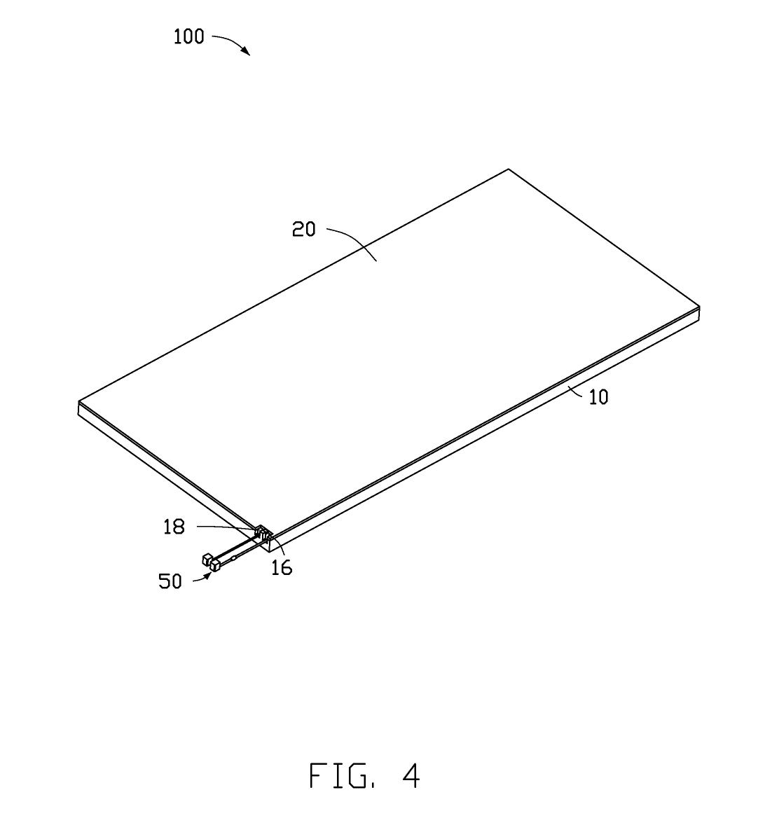

In at least one embodiment, the battery cover 20 detachably covers the housing 10. One end of the battery cover 20 defines a notch 22, and a block 24 is protruded from the battery cover 20 to divide the notch 22 into a first notch 222 and a second notch 224. When the battery cover 20 engages with the housing 10, the first notch 222 communicates with the first opening 144 to jointly define a first outlet 16 (see FIG. 4), the second notch 224 communicates with the second opening 146 to jointly define a second outlet 18 (see FIG. 4), and the block 24 is perpendicularly aligned with the protrusion 142.

In another embodiment, the first opening 144 and the second opening 146 are defined at two opposite sides of the at least one peripheral plate 12, respectively, and the first notch 222 and the second notch 224 are also defined at two opposite sides of the battery cover 20, respectively.

The PCB 30 is disposed on the bottom plate 11 of the housing 10. An end of the PCB defines a recess 31 communicating with the first outlet 16 and the second outlet 18.

Additionally, the PCB 30 includes a detecting pin 32, a plurality of connecting pins 33, and a processor 34 electronically connected to the detecting pin 32 and the plurality of connecting pins 33. The processor 34 may control audio output to the headset assembly 50 through the connecting pins 33. Detailed descriptions will be illustrated below.

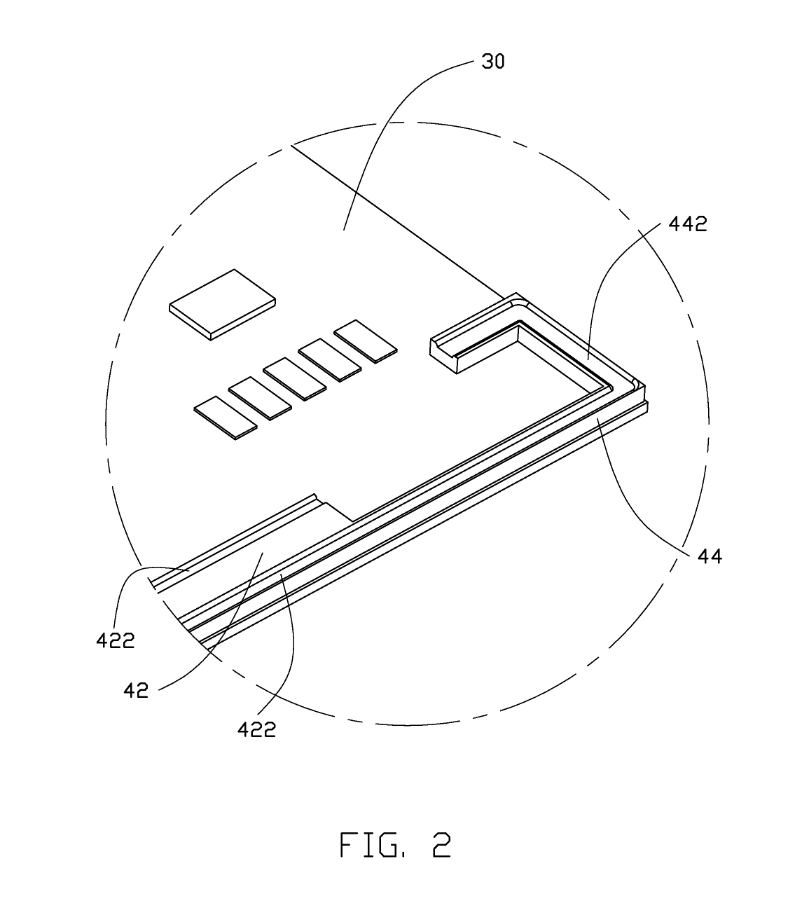

FIG. 2 illustrates that the rail 40 can be integrally formed on the PCB 30 for guiding a movement of the headset assembly 50. In detail, the rail 40 includes a main plate 42 and an extending plate 44 extending from an end of the main plate 42. The main plate 42 defines two guiding grooves 422 separated from each other. The extending plate 44 is substantially a U-shaped sheet and defines an extending groove 442 communicating with one of the two guiding grooves 422. In other embodiments, the rail 40 can be detachably fixed to the PCB 30.

The headset assembly 50 can be withdrawn from and retracted into the housing 10. In at least one embodiment, the headset assembly 50 includes two earphones 52 and two cables 54, and each cable 54 is electronically coupled to a corresponding earphone 52. The two earphones 52 are disposed in the recess 31 of the PCB 30 and can be exposed from the first outlet 16 and the second outlet 18, respectively. One of the two cables 54 slides in one of the two guiding grooves 422, and is directed by the reeling mechanism 70. Another one of the two cables 54 slides in another one of the two guiding grooves 422 and the extending groove 442, and is also directed by the reeling mechanism 70. Optionally, a microphone 56 may be incorporated into the headset assembly 50 and is disposed on one of the two cables 54 to facilitate picking up sounds from users.

The reeling mechanism 70 is secured on the PCB 30 for extending/retracting the two cables 54. Optionally, a control mechanism (not shown) may be incorporated into the reeling mechanism 70 for clockwise/anticlockwise rotation to allow the two cables 54 to be manually withdrawn from the housing 10 and to be automatically rewound. The control mechanism is well known by those skilled in the art; detailed descriptions thereof are omitted here. In at least one embodiment, the reeling mechanism 70 includes two opposite apertures 72 corresponding to the main plate 42 and the extending plate 44, respectively, to allow the two cables 54 to respectively pass through the two opposite apertures 72.

The reeling mechanism 70 further includes an urging member 74 (for example, a spring) configured to actuate the detecting pin 32. The urging member 74 is coupled to the control mechanism. When the two cables 54 are withdrawn from the housing 10, the urging member 74 is directed by the control mechanism and is in an elastically deformed state, and then the detecting pin 32 is floating. When the two cables 54 are retracted into the housing 10, the urging member 74 is directed by the control mechanism to return to its original state, and a distal end of the urging member 74 is electronically contacted with the detecting pin 32. Thus, the detecting pin 32 may trigger a first control signal (for example, a logic “1”) to the processor 34 while the two cables 54 are withdrawn from the housing 10 and trigger a second control signal (for example, a logic “0”) to the processor 34 while the two cables 54 are retracted into the housing 10. The plurality of connecting pins 33 and the processor 34 are electronically coupled to the two cables 54 and the processor 34 is configured to activate the headset assembly 50 in response to the first control signal. An indication icon (not shown) may be shown on the touch screen to notify the user of the activation of the headset assembly 50.

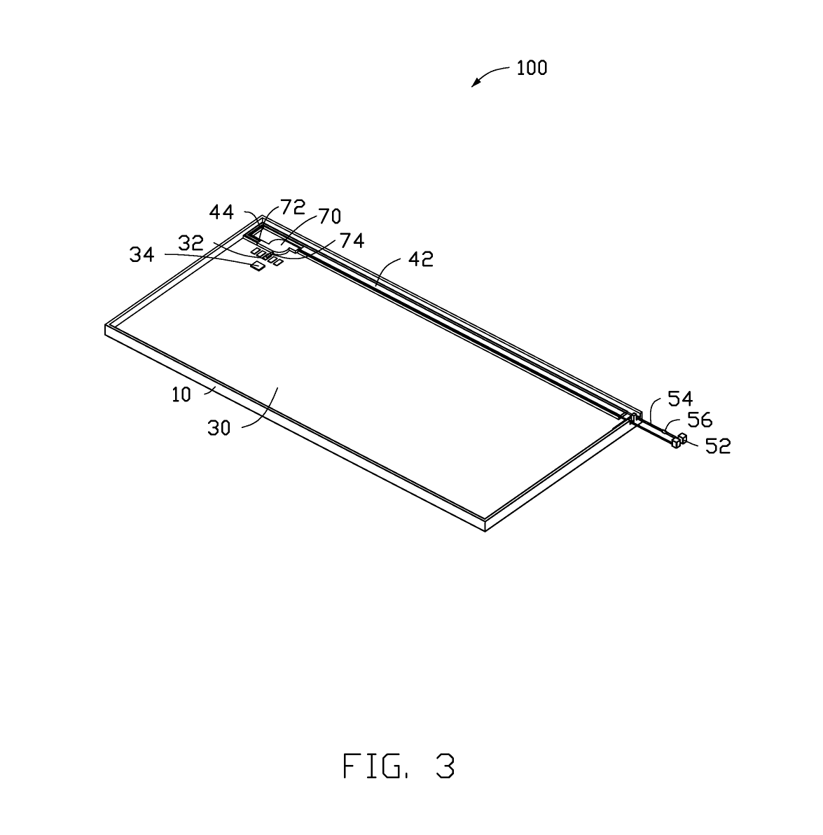

Referring to FIG. 3, in assembly, the reeling mechanism 70 is secured on the PCB 30 to allow the urging member 74 to contact with the detecting pin 32. The headset assembly 50 is received in the housing 10. Thus, the two cables 54 can be slidably received in the two guiding grooves 422 and the extending groove 442, and are directed by the reeling mechanism 70. Additionally, the two earphones 52 are partially exposed from the first outlet 16 and the second outlet 18, respectively, to facilitate manipulation by users.

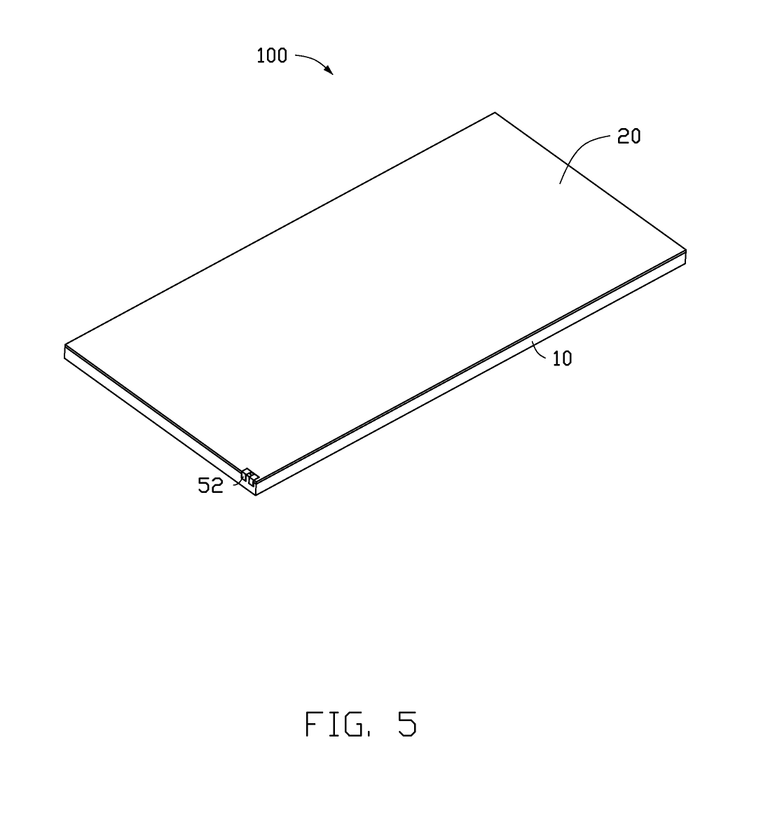

Referring to FIGS. 4-5, in use, when the headset assembly 50 is manually withdrawn from the housing 10, the two cables 54 slide in the two guiding grooves 422 to deform the urging member 74. At this time, the detecting pin 32 is floating and triggers the first control signal. Thus, the headset assembly 50 is activated by the processor 34. Alternatively, when the headset assembly 50 is retracted into the housing 10, the urging member 74 returns to its original state to electronically contact with the detecting pin 32, and then the detecting pin 32 triggers the second control signal. Thus, the processor 34 inactivates the headset assembly 50 in response to the second control signal.

In summary, the headset assembly 50 can be withdrawn from and retracted into the housing 10. Thus, the electronic portable device 100 can automatically determines a position of the headset assembly 50, and a user can activate an earphone mode simply by removing the headset assembly 50 from housing 10. Thus, the portable electronic device 100 integrated with the extendable and retractable headset assembly 50 is both intelligent and convenient.

Additionally, the two cables 54 slide along the rail 40, and the two earphones 52 are partially exposed from the first outlet 16 and the second outlet 18. Thus, it is sufficient to efficiently ensure that the headset assembly 50 does not intertwine for the entire duration of the movement, from extension to retraction.

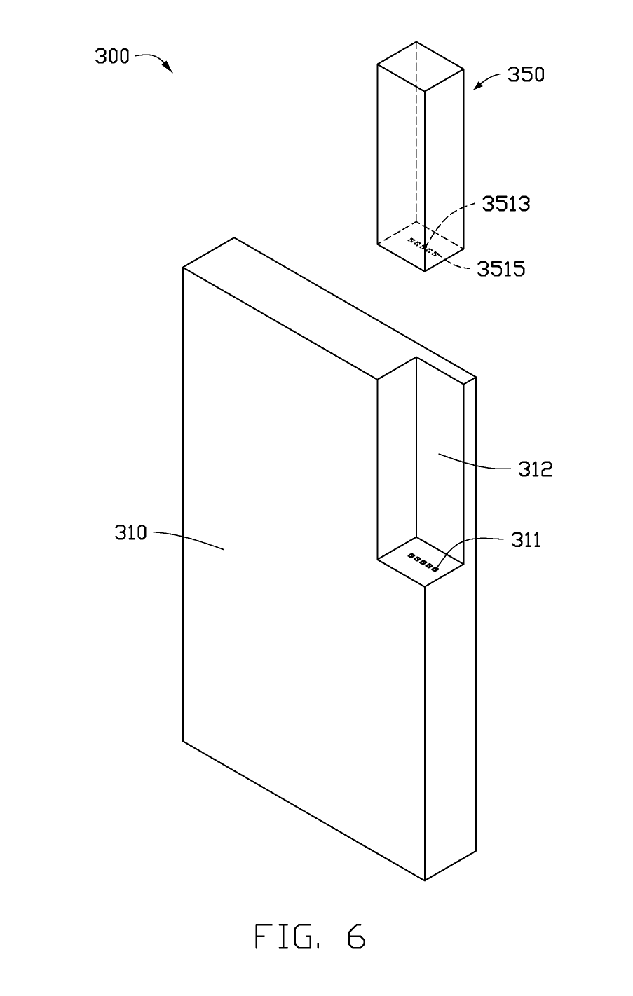

FIG. 6 illustrates an embodiment of a portable electronic device 300 employing a headset module 350, according to a second exemplary embodiment. The portable electronic device 300 further includes a housing 310, a plurality of pins 311, and a processor (not shown) electronically connected to the plurality of pins 311. The housing 310 defines a mounting space 312 recessed in one end, and the plurality of pins 311 are exposed from the mounting space 312. In at least one embodiment, the mounting space 312 is a substantially rectangular shape.

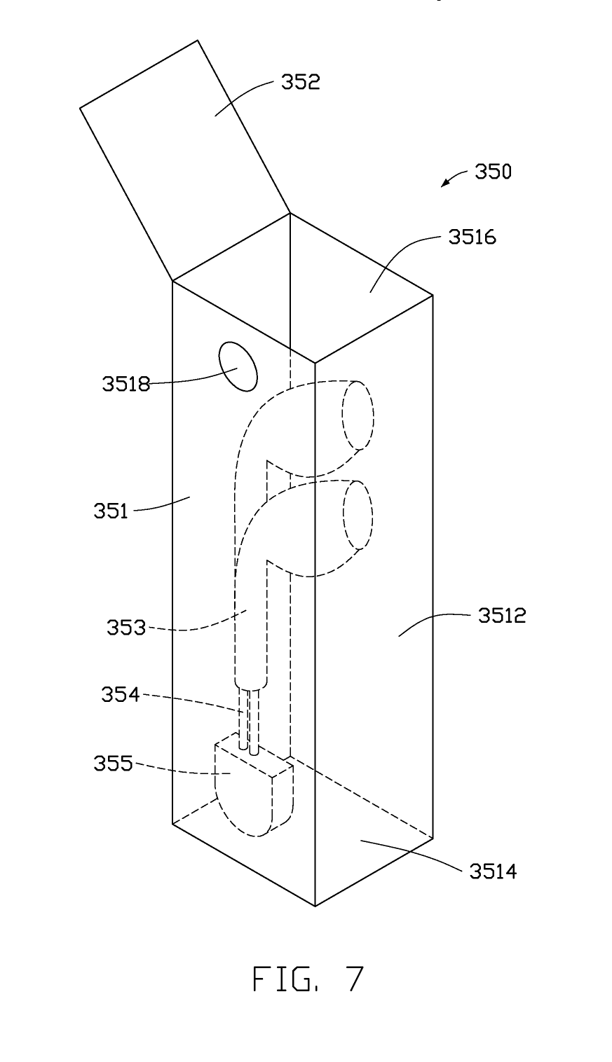

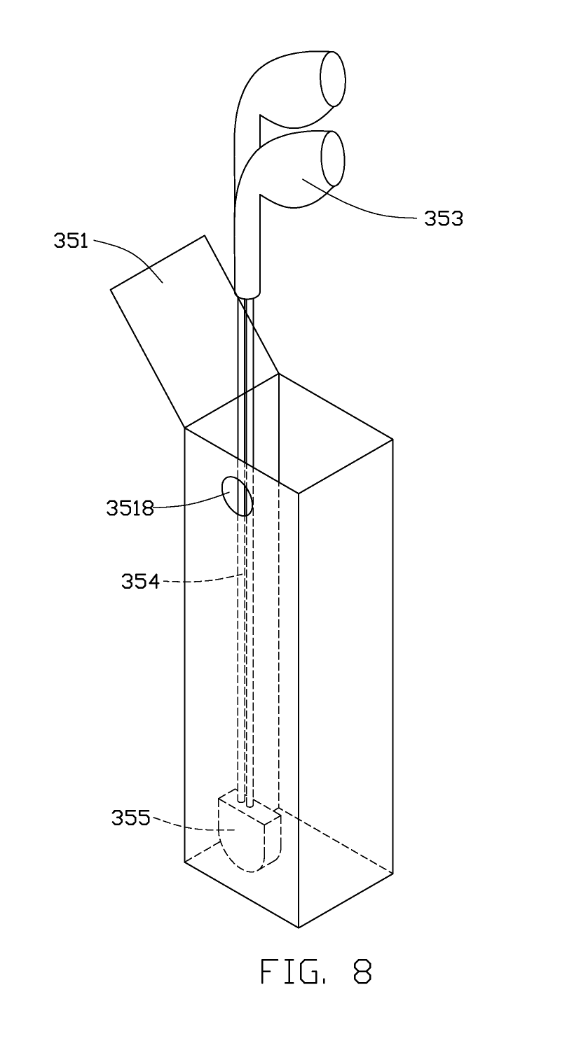

FIG. 7 and FIG. 8 illustrate that the headset module 350 includes a receiving portion 351, a cover 352, a reeling mechanism 355, and a headset assembly having two earphones 353 and two cables 354. The receiving portion 351 is substantially a hollow structure defining an enclosed interior space, and a shape of the receiving portion 351 is associated with the mounting space 312. Thus, the receiving portion 351 can be detachably mounted in the mounting space 312 via a latching structure (not shown). In other embodiments, the receiving portion 351 is integrally formed with the housing 310.

In at least one embodiment, the receiving portion 351 is a rectangular frame and includes four side walls 3512 connected end to end and a bottom wall 3514 sealing an end of the four side walls 3512. The receiving portion 351 further defines an outlet 3516 opposite to the bottom wall 3514 and communicating with the enclosed interior space. A detecting pin 3513 and a plurality of connecting pins 3515 (see FIG. 6) are disposed on the bottom wall 3514 and are interconnected to the plurality of pins 311, respectively. In addition, one of the four side walls 3512 forms a jack 3518 electronically connected to the detecting pin 3513 and the plurality of connecting pins 3515, and the jack 3518 is configured to receive a plug of an external earphone.

The cover 352 is hinged to the receiving portion 351 to open or close the outlet 3516. The two earphones 353, the two cables 354, and the reeling mechanism 355 are received in the enclosed interior space of the receiving portion 351, and each cable 354 is electronically coupled to a corresponding earphone 353. Structures and functions of the reeling mechanism 355 are substantially equal to the reeling mechanism 70 of the first exemplary embodiment, and thus detailed descriptions are omitted here.

In use, the cover 351 is rotated relative to the receiving portion 351 to open the outlet 3516, the two earphones 353 are withdrawn from the receiving portion 351, an urging member of the reeling mechanism 355 is in an elastically deformed state, and then the detecting pin 3513 is floating and triggers a first control signal. Thus, the headset assembly is activated by the processor. Alternatively, when the two earphones 353 are retracted into the receiving portion 351, the urging member of the reeling mechanism 355 returns to its original state to electronically contact with the detecting pin 3513, and then the detecting pin 32 triggers a second control signal. Thus, the headset assembly is inactivated by the processor.

Further, when the plug of an external earphone is inserted into the jack 3518 to actuate the detecting pin 3513, the processor may activate the external earphone in response to receiving another control signal output from the detecting pin 3513.

The embodiments shown and described above are only examples. Many details are often found in the art such as the other features of the portable electronic device integrated with the extendable and retractable headset assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A portable electronic device integrated with an extendable and retractable headset assembly, wherein the portable electronic device defines a substantially enclosed interior space and comprises:
a detecting pin and a processor electronically connected to the detecting pin; and
a reeling mechanism configured for clockwise and anticlockwise rotation to drive the headset assembly to be withdrawn from and retracted into the enclosed interior space;
wherein the reeling mechanism comprises an urging member; and
wherein when the headset assembly is withdrawn from the enclosed interior space, the urging member activates the detecting pin to signal the processor to activate the headset assembly; and
wherein when the headset assembly is retracted into the enclosed interior space, the urging member activates the detecting pin to signal the processor to deactivate the headset assembly.

2. The portable electronic device as claimed in claim 1, further comprising a rail and a printed circuit board (PCB), wherein the rail is integrally formed on the PCB of the portable electronic device for guiding a movement of the headset assembly.

3. The portable electronic device as claimed in claim 2, wherein the rail comprises a main plate and an extending plate extending from an end of the main plate, the main plate defines two guiding grooves separated from each other, the extending plate defines an extending groove communicating with one of the two guiding grooves.

4. The portable electronic device as claimed in claim 3, wherein the headset assembly comprises two earphones and two cables electronically coupled to the two earphones, respectively, one of the two cables slides in one of the two guiding grooves and is directed by the reeling mechanism, and another one of the two cables slides in another one of the two guiding grooves and the extending groove and is also directed by the reeling mechanism.

5. The portable electronic device as claimed in claim 4, wherein the reeling mechanism is secured on the PCB and further comprises two apertures corresponding to the main plate and the extending plate, respectively, to allow the two cables to respectively pass through the two apertures.

6. The portable electronic device as claimed in claim 1, further comprising a housing, wherein the housing comprises at least one peripheral plate, the at least one peripheral plate defines an opening, and a protrusion is protruded from the at least one peripheral plate to divide the opening into a first opening and a second opening.

7. The portable electronic device as claimed in claim 6, further comprising a battery cover engaging with the housing to define the enclosed interior space, wherein the battery cover defines a notch, and a block is protruded from the battery cover to divide the notch into a first notch and a second notch, the first notch communicates with the first opening to jointly define a first outlet, the second notch communicates with the second opening to jointly define a second outlet, and the block is perpendicularly aligned with the protrusion.

8. The portable electronic device as claimed in claim 7, wherein the headset assembly comprises two earphones, the two earphones are exposed from the first outlet and the second outlet, respectively.

9. The portable electronic device as claimed in claim 1, further comprising a housing and a headset module, wherein the housing defines a mounting space, the headset module comprises a receiving portion and a cover, the receiving portion is substantially a hollow structure defining the enclosed interior space and receives the reeling mechanism and the headset assembly in the enclosed interior space, the receiving portion is mounted in the mounting space and defines an outlet communicating with the enclosed interior space, and the cover is hinged to the receiving portion to open or close the outlet.

10. The portable electronic device as claimed in claim 9, wherein a plurality of pins are exposed from the mounting space, the receiving portion comprises a plurality of side walls connected end to end and a bottom wall sealing an end of the side walls, the detecting pin is disposed on the bottom wall and is interconnected to one of the plurality of pins, one of the side walls forms a jack electronically connected to the detecting pin, and the jack is configured to receive a plug of an external earphone.

11. A portable electronic device integrated with an extendable and retractable headset assembly, the portable electronic device comprising:
a housing;
a battery cover engaging with the housing;
a printed circuit board (PCB) received in the housing and comprising a detecting pin and a processor electronically connected to the detecting pin;
a rail formed on the PCB for guiding a movement of the headset assembly; and
a reeling mechanism secured on the PCB and driving the headset assembly to be withdrawn from and retracted into the housing;
wherein the reeling mechanism comprises an urging member, the urging member actuates the detecting pin to trigger a first control signal or a second control signal in response to the movement of the headset assembly, the processor determines whether to activate or inactivate the headset assembly according to the first control signal and the second control signal.

12. The portable electronic device as claimed in claim 11, wherein
when the headset assembly is withdrawn from the housing, the urging member is in an elastically deformed state and the detecting pin is floating and triggers the first control signal to the processor,
when the headset assembly is refracted into the housing, the urging member returns to its original state and is electronically contacted with the detecting pin and the detecting pin triggers the second control signal to the processor.

13. The portable electronic device as claimed in claim 11, wherein the rail comprises a main plate and an extending plate extending from an end of the main plate, the main plate defines two guiding grooves separated from each other, the extending plate defines an extending groove communicating with one of the two guiding grooves.

14. The portable electronic device as claimed in claim 13, wherein the headset assembly comprises two earphones and two cables electronically coupled to the two earphones, respectively, one of the two cables slides in one of the two guiding grooves and is directed by the reeling mechanism, and another one of the two cables slides in another one of the two guiding grooves and the extending groove and is also directed by the reeling mechanism.

15. The portable electronic device as claimed in claim 14, wherein the reeling mechanism further comprises two apertures corresponding to the main plate and the extending plate, respectively, to allow the two cables to respectively pass through the two apertures.

16. The portable electronic device as claimed in claim 14, wherein the housing comprises at least one peripheral plate, the at least one peripheral plate defines an opening, and a protrusion is protruded from the at least one peripheral plate to divide the opening into a first opening and a second opening.

17. The portable electronic device as claimed in claim 16, wherein the battery cover defines a notch, and a block protrudes from the battery cover to divide the notch into a first notch and a second notch, the first notch communicates with the first opening to jointly define a first outlet, the second notch communicates with the second opening to jointly define a second outlet, the block is perpendicularly aligned with the protrusion, and the two earphones are exposed from the first outlet and the second outlet, respectively.

18. A portable electronic device integrated with an extendable and retractable headset assembly, the headset assembly having at least one earphone connected to one or more earphone cables, wherein the portable electronic device defines a substantially enclosed interior space and comprises:
a reeling mechanism positioned within the enclosed interior space, the reeling mechanism having an urging member;
a detecting pin; and
a processor electronically connected to the detecting pin and controlling audio output to the headset assembly;
wherein the one or more earphone cables are engaged with the reeling mechanism, the reeling mechanism selectively drives the one or more earphone cables to be withdrawn from the enclosed interior space and to be retracted into the enclosed interior space;
wherein the urging member elastically deforms from an original state when the one or more earphone cables are withdrawn from the enclosed interior space and the urging member returns to the original state when the one or more earphone cables are retracted into the enclosed interior space;
wherein withdrawal of the one or more earphone cables activates the detecting pin to signal the processor to activate the headset assembly; and
wherein retraction of the one or more earphone cables activates the detecting pin to signal the processor to deactivate the headset assembly.

19. The portable electronic device as claimed in claim 18, further comprising a housing and a headset module, wherein the housing defines a mounting space, the headset module comprises a receiving portion and a cover, the receiving portion is substantially a hollow structure defining the enclosed interior space and receives the reeling mechanism and the headset assembly in the enclosed interior space, the receiving portion is mounted in the mounting space and defines an outlet communicating with the enclosed interior space, and the cover is hinged to the receiving portion to open or close the outlet.

20. The portable electronic device as claimed in claim 19, wherein a plurality of pins are exposed from the mounting space, the receiving portion comprises a plurality of side walls connected end to end and a bottom wall sealing an end of the side walls, the detecting pin is disposed on the bottom wall and is interconnected to one of the plurality of pins, one of the side walls forms a jack electronically connected to the detecting pin, and the jack is configured to receive a plug of an external earphone.
